(19) United States
(12) Patent Application Publication
(10) Pub. No.: US 2017/0096601 A1
(43) Pub. Date: Apr. 6, 2017

(54) LIQUID CRYSTAL COMPOSITION

(71) Applicant: DONGJIN SEMICHEM CO., LTD., Incheon (KR)

(72) Inventors: Sun Hee LEE, Hwaseong (KR); Bong Hee KIM, Hwaseong (KR); Tae Pyo CHO, Hwaseong (KR); Byung Uk KIM, Hwaseong (KR)

(21) Appl. No.: 15/281,029

(22) Filed: Sep. 29, 2016

(30) Foreign Application Priority Data
Oct. 2, 2015 (KR) 10-2015-0139197

(51) Int. Cl. C09K 19/30

(52) U.S. Cl. CPC C09K 19/3003; C09K 2019/3004; C09K 2019/301; C09K 2019/3016; C09K 2019/3019

(57) ABSTRACT

The present invention relates to a liquid crystal composition. The liquid crystal composition has low rotational viscosity, and simultaneously, has excellent low temperature stability, and thus, can be usefully used in IPS (In-Plane Switching) or FFS (Fringe-Field Switching) mode TV or monitors which require low voltage driving and high speed response properties, and liquid crystal display devices such as mobile notebooks or tablet PCs, which particularly requires low temperature stability.

### CROSS-REFERENCE TO RELATED APPLICATIONS

This application claims priority to and the benefit of Korean Patent Application No. 10-2015-0139197, filed on Oct. 2, 2015 in the Korean Intellectual Property Office, the entire contents of which are incorporated herein by reference.

### TECHNICAL FIELD

The present invention relates to a liquid crystal composition that has excellent low temperature stability, and simultaneously, exhibits low rotational viscosity required to realize a high response speed of a liquid crystal display device.

### BACKGROUND

Liquid crystal display devices (LCD) are used in various electric appliances including clocks and electronic calculators, measuring apparatuses, automobile panels, word processors, electronic notebooks, printers, computers, televisions, and the like. Representative liquid crystal display modes include TN (Twist nematic), STN (Super-twisted nematic), IPS (In-plane switching), FFS (Fringe field switching) and VA (Vertical alignment), and the like.

It is required that liquid crystal materials used in the liquid crystal display devices are capable of low voltage driving and high speed response, and operating at a wide temperature range. Specifically, in order to stably drive at a wide temperature range, the liquid crystal material is required to exhibit stable properties at a temperature of about −20° C. or less (low temperature stability) and have a clearing point of about 70° C. or more. In the case of low temperature stability, it is required to be stable even at −25° C. so as to prepare for long time exposure to the external environmental of particularly low temperature. And, for low voltage driving and high speed response, the liquid crystal material is required to have a large absolute value of dielectric anisotropy and low rotational viscosity.

A single liquid crystal compound making up such a liquid crystal composition is organic material having a molecular weight of about 200˜600 and has a molecular structure of a long bar shape. The structure of the single liquid crystal compound is divided into core groups maintaining straightness, terminal groups having flexibility, and linkage groups for specific use. The terminal groups consist of easily bendable chains (alkyl, alkoxy, alkenyl) on one or both sides, thus maintaining flexibility, and polar groups (F, CN, OCF₃ and the like) are introduced into the other side to perform a function for controlling the properties of liquid crystal such as dielectric constant.

With continued development of single liquid crystal compounds applied for liquid crystal display devices for several decades, various forms of single liquid crystal compounds have been developed. And, various liquid crystal compositions have been provided by appropriately combining them. However, there are a lot of things that need to be improved with regard to performances of liquid crystal display devices, and there is a continued demand for the development of liquid crystal compositions that can solve these problems.

Recently, in the case of an IPS TV or monitor manufactured with a large area, or a notebook or a table PC mainly used for the realization of video, it is important to have a low threshold voltage and a short response time. Thus, liquid crystal compositions having a high dielectric anisotropy and a low rotational viscosity should be used in the liquid crystal display devices. And, mobile devices such as a notebooks or a table PC are mainly carried by a user and used, and particularly require stability at low temperature of −25° C. or less, and a TV or a monitor and the like may be placed at extreme low temperature during the process of transportation, thus requiring low temperature stability.

Although a method of providing a liquid crystal composition by appropriately mixing liquid crystal compounds having similar melting points so as to exhibit low temperature stability has been suggested, a liquid crystal composition that exhibits sufficient stability at low temperature while maintaining good properties has not be suggested yet, and the studies thereon is urgently needed.

### DISCLOSURE

### Technical Problem

It is an object of the present invention to provide a liquid crystal composition that exhibits low rotational viscosity while maintaining a liquid crystal phase at low temperature, by controlling the contents and the mixing ratio of liquid crystal compounds having weak low temperature stabilities.

### Technical Solution

Hereinafter, a liquid crystal composition according to specific embodiments of the invention will be explained.

According to one embodiment of the invention, a liquid crystal composition comprising a first liquid crystal compound represented by the following Chemical Formula 1, a second liquid crystal compound represented by the following Chemical Formula 2, and a third liquid crystal compound represented by the following Chemical Formula 3, wherein the first liquid crystal compound and the second liquid crystal compound are included in the content of 10 to 40 wt %, based on the total weight of the total liquid crystal compounds, and the first liquid crystal compound and the second liquid crystal compound are included at a weight ratio of 1:0.5 to 1:1.5, is provided:

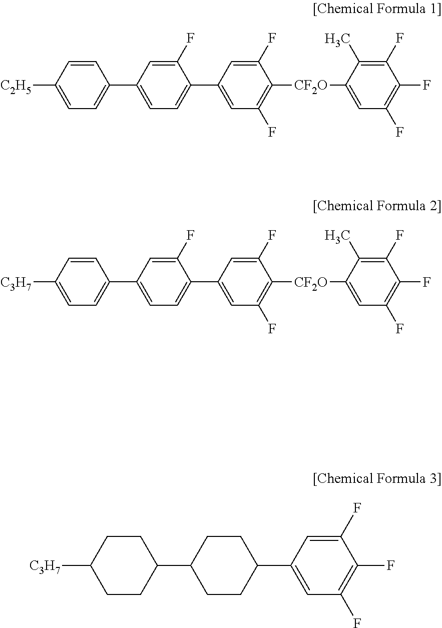

Unless specifically limited herein, the following terms may be defined as follows.

Halogen may be fluorine (F), chlorine (Cl), bromine (Br) or iodine (I).

An alkyl radical may be a linear, branched or cyclic alkyl radical. Specifically, an alkyl radical may be methyl, ethyl, propyl, butyl, pentyl, hexyl, heptyl, octyl, cyclohexyl or structural isomers thereof.

And, if specifically limited, an alkyl radical may be replaced with an alkyl radical of which at least one H is substituted with halogen. For example, an ethyl radical may be replaced with a perfluoroethyl (—CF₂CF₃) radical wherein all H's of the ethyl radical (—CH₂CH₃) are substituted with F.

And, if specifically limited, an alkyl radical may be replaced with an alkyl radical of which at least one —CH₂— is substituted with —C≡C—, —CF₂O—, —CH═CH—, —O—, —COO—, —OCO— or —OCO—O—. For example, an ethyl radical may be replaced with an allyl radical (—CH₂—CH═CH—H) wherein the —CH₂— of the ethyl radical (—CH₂—CH₂—H) is substituted with —CH═CH—. However, at least one —CH₂— of the radical should be substituted with the above substituents so that oxygen atoms may not be directly connected.

The first liquid crystal compound represented by the Chemical Formula 1 affords not only low rotational viscosity but also high clearing point to the liquid crystal composition. However, as the result of studies of the present inventors, it was confirmed that the first liquid crystal compound may reduce low temperature stability of a liquid crystal composition, and particularly, when the first liquid crystal compound is used in the content of 10 wt % or more, based on the total weight of the total liquid crystal compounds, it rapidly reduces low temperature stability. As used herein, the word “low temperature stability” means stable property at a low temperature.

To the contrary, the second liquid crystal compound represented by the Chemical Formula 2 may remarkably improve low temperature stability of a liquid crystal composition. However, the second liquid crystal compound does not have excellent rotational viscosity, and thus, it is difficult to be applied for liquid crystal display devices for the realization of videos which require high speed response.

The present inventors confirmed that if the first and the second liquid crystal compounds which have fatal drawbacks when used respectively are mixed with a third liquid crystal compound represented by the above Chemical Formula 3, and the content and the mixing ratio of the first and the second liquid crystal compounds are controlled, the drawbacks of the first and the second liquid crystal compounds may be compensated and the advantages thereof may be maximized, and completed the present invention.

Specifically, the first and the second liquid crystal compounds may be used in the content of 10 to 40 wt %, based on the total weight of the total liquid crystal compounds included in the liquid crystal composition, and they may be mixed at a weight ratio of 1:0.5 to 1:1.5 within the above explained content range. Out of these ranges, low temperature stability may rapidly become inferior or rotational viscosity may increase. However, by mixing the first and the second liquid crystal compounds at the above weight ratio within the above content range, a liquid crystal composition that exhibits low rotational viscosity and has high clearing point and excellent low temperature stability may be provided.

The third liquid crystal compound represented by the Chemical Formula 3 may be mixed with the first and the second liquid crystal compounds to perform a function for improving low temperature stability.

And, the third liquid crystal compound exhibits low refractive index anisotropy, and may appropriately control the refractive index anisotropy excessively increased by the first and the second liquid crystal compounds. Specifically, the transmittance of a liquid crystal display device is related to a phase difference value calculated by the product of a cell gap (d) and a refractive index anisotropy (Δn). However, the liquid crystal composition according to one embodiment of the present invention essentially comprise the first and a second liquid crystal compounds including benzene rings substituted with halogen, and thus, exhibits relatively high refractive index anisotropy. Thus, by controlling the content of the third liquid crystal compound so that the liquid crystal composition may exhibit appropriate refractive index anisotropy according to the cell gap, the transmittance of a liquid crystal display device may be improved.

The third liquid crystal compound may be included in the content of 2 to 20 wt %, based on the total weight of the total liquid crystal compounds, in order to provide a liquid crystal composition having improved low temperature stability and appropriate refractive index anisotropy. If the content of the third liquid crystal compound does not fall within the above range, low temperature stability may be rather decreased.

Meanwhile, the liquid crystal composition according to one embodiment of the present invention may further comprise a forth liquid crystal compound represented by the following Chemical Formula 4.

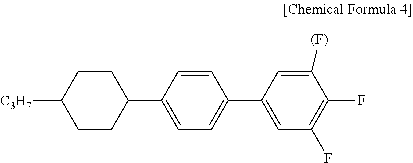

In the Chemical Formula 4, (F) denotes being unsubstituted or substituted with F.

The fourth liquid crystal compound is a liquid crystal compound exhibiting a refractive index anisotropy of 8 to 12, and exhibiting good low temperature stability. Thus, the liquid crystal composition may further comprise the fourth liquid crystal compound to exhibit higher stability at low temperature.

The fourth liquid crystal compound may be included in the content of 2 to 30 wt % based on the total weight of the total liquid crystal compounds, thereby further improving low temperature stability of the liquid crystal composition.

In the liquid crystal composition according to one embodiment of the invention, various liquid crystal compounds known in the technical field to which the present invention pertains may be included, in addition to the above explained first to fourth liquid crystal compounds.

Specifically, the liquid crystal composition may further comprise one or more liquid crystal compounds selected from the group consisting of liquid crystal compounds represented by the following Chemical Formula 5 to Chemical Formula 8.

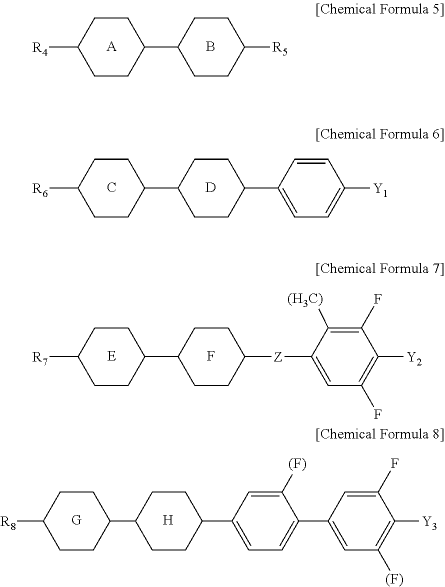

in the Chemical Formulae 5 to 8, each of R₄, R₅, R₆, R₇ and R₈ are independently a C1-7 alkyl radical, or a C1-7 alkyl radical of which at least one H is substituted with halogen, or at least one —CH₂— is replaced with —C≡C—, —CF₂O—, —CH═CH—, —O—, —CO—O—, —O—CO— or —O—CO—O— so that oxygen atoms are not directly connected,

Y₁ is a C1-7 alkyl radical, F or OCF₃,

each of Y₂ and Y₃ are independently F, OCF₃ or CF₃,

each of the ring A, ring B, ring C, ring E and ring G are independently cyclohexylene or phenylene,

each of the ring D, ring F and ring H are independently cyclohexylene, phenylene, fluorophenylene or difluorophenylene,

Z is a single bond, —CF₂O—, or —CH₂CH₂—,

(CH₃) denotes being unsubstituted or substituted with a methyl radical, and

(F) denotes being unsubstituted or substituted with F,

provided that among the structures derived from the Chemical Formula 7, the structures of the Chemical Formula 3 and Chemical Formula 4 are excluded.

The liquid crystal compound represented by the Chemical Formula 5 may be included in the content of 50 parts by weight or less or 0.01 to 50 parts by weight based on the total weight of the total liquid crystal compounds, the liquid crystal compound represented by the Chemical Formula 6 may be included in the content of 30 parts by weight or less or 0.01 to 30 parts by weight based on the total weight of the total liquid crystal compounds, the liquid crystal compound represented by the Chemical Formula 7 may be included in the content of 20 parts by weight or less or 0.01 to 20 parts by weight based on the total weight of the total liquid crystal compounds, and the liquid crystal compound represented by the Chemical Formula 8 may be included in the content of 10 parts by weight or less or 0.01 to 10 parts by weight based on the total weight of the total liquid crystal compounds.

And, the liquid crystal composition according to one embodiment of the present invention may further comprise various additives known in the technical field to which the present invention pertains. The additives may include an antioxidant or an UV absorbent and the like.

Meanwhile, according to another embodiment of the present invention, a liquid crystal display device comprising the above explained liquid crystal composition is provided. The liquid crystal display device comprises a liquid crystal composition that exhibits excellent properties such as low rotational viscosity and high clearing point, and the like, and simultaneously has excellent low temperature stability as explained above, thereby enabling low voltage driving due to low threshold voltage and enabling high speed response. Thus, the liquid crystal display device may be provided as IPS (In-Plane Switching) or FFS (Fringe-Field Switching) mode TV or monitors, which are provided with large areas, or it may be provided as a mobile notebook or tablet PC, which requires a rapid response speed for video operation and requires low temperature stability so as to be carried by a user.

### Advantageous Effects

The liquid crystal composition according to one embodiment of the present invention simultaneously has low rotational viscosity and excellent low temperature stability, and thus, it may be usefully used in IPS (In-Plane Switching) or FFS (Fringe-Field Switching) mode TV or monitor which requires low voltage driving and high speed response properties, and a liquid crystal display device such as a mobile notebooks or tablet PC, which particularly requires low temperature stability.

### DETAILED DESCRIPTION OF THE EMBODIMENTS

Hereinafter, the actions and the effects of the present invention will be explained in detail through specific examples. However, these are presented only to illustrate the invention, and the scope of the invention is not limited thereto.

The properties of the liquid crystal composition prepared below were assessed using the methods described below.

(1) Clearing Point (Tni)

A drop of a liquid crystal composition of which clearing point was to be measured was dripped with a dropping pipet on a slide glass, which was then covered with a cover glass to prepare a sample for measuring a clearing point.

The sample was put in an apparatus equipped with a METTLER TOLEDO FP90 temperature regulator, and while raising the temperature with a FP82HT Hot stage at a speed of 3° C./min, the change of the sample was observed. The temperature at which a hole was generated in the sample was reported, and this operation was repeated three times to derive an average value. And, this value is defined as a clearing point of the liquid crystal composition.

(2) Refractive index anisotropy (Δn) The refractive index anisotropy (Δn) of the liquid crystal composition was measured with an Abbe's refractometer equipped with a polarizing plate on an eyepiece using light of wavelength of 589 nm at 20° C. The surface of the main prism was rubbed in one direction, and then, the liquid crystal composition to be measured was loaded on the main prism. Thereafter, refractive index (n II) when the direction of polarization and the direction of rubbing are parallel and the refractive index (n⊥) when the direction of polarization is vertical to the direction of rubbing were measured. And, the values of the refractive indexes were substituted in the following Equation 1 to measure refractive index anisotropy (Δn).

Δn=n∥−n⊥ [Equation 1]

(3) Dielectric Anisotropy (Δ∈)

The dielectric anisotropy of the liquid crystal composition was calculated by substituting ∈∥ and ∈⊥ measured as follows in the Equation 2.

Δ∈=∈∥−∈⊥ [Equation 2]

\textcircled{1} Measurement of dielectric constant ∈∥: On the sides of two glass substrates on which ITO patterns are formed, a vertical aligning agent was coated to form vertical alignment layers. Subsequently, a spacer was coated on any one substrate of the two glass substrates, and then, the two glass substrates were bonded, such that the vertical alignment layers faced each other and the distance (cell gap) between the two glass substrates became 4 μm. And, a liquid crystal composition to be measured was injected into the device, which was sealed with UV curable adhesive. Thereafter, using 4294A equipment manufactured by Agilent, dielectric constant (∈∥) of the device was measured at 1 kHz, 0.3 V and 20° C.

\textcircled{2} Measurement of dielectric constant ∈⊥: On the sides of two glass substrates on which ITO patterns are formed, a parallel aligning agent was coated to form parallel alignment layers. Subsequently, a spacer was coated on any one substrate of the two glass substrates, and then, the two glass substrates were bonded, such that the parallel alignment layers faced each other and the distance (cell gap) between the two glass substrates became 4 μm. And, a liquid crystal composition to be measure was injected into the device, which was sealed with UV curable adhesive. Thereafter, using 4294A equipment manufactured by Agilent, dielectric constant (∈⊥) of the device was measured at 1 kHz, 0.3 V and 20° C.

(4) Rotational Viscosity (γ)

On the sides of two glass substrates on which ITO patterns are formed, a parallel aligning agent was coated to form parallel alignment layers. Subsequently, a spacer was coated on any one substrate of the two glass substrates, and then, the two glass substrates were bonded, such that the parallel alignment layers faced each other and the distance (cell gap) between the two glass substrates became 20 μm. And, a liquid crystal composition was injected into the device, which was sealed with UV curable adhesive. Thereafter, using Model 6254 equipment (Toyo Corp.) equipped with a temperature controller manufactured by ESPEC Corp. (Model SU-241), the rotational viscosity of the device was measured at 20° C.

(5) Low Temperature Stability

Into a 10 mL vial, 2 mL of a liquid crystal composition to be measured was introduced. And, the vial containing the liquid crystal composition was allowed to stand in a freezer of −25° C., and then, it was confirmed once a day for 5 days whether or not a crystal or smetic phase was generated. If a crystal or smetic phase is generated after a few days, it was marked as ‘NG at the observed day’, and if a nematic phase is maintained for 5 days, it was marked as ‘5 days OK’.

### Examples and Comparative Examples: Preparation of a Liquid Crystal Composition

The liquid crystal compounds used in Examples and Comparative Examples are indicated as codes. The code describes the symbol of the ring making up the core groups of the liquid crystal compound from the left, describes the linkage groups that connect the rings of the core groups according to the sequence, and then, describes the terminal groups at right side. Wherein, although there is no separate distinguishing mark between the rings of the core groups and the linkage groups connecting the rings of the core groups, “-” is described between the core group and the terminal group to distinguish them, and both terminal groups are distinguished by “.”. Individual informal symbols (codes) of materials are summarized in the following Table 1.

TABLE 1

| Core groups | | Linkage groups | | Terminal groups | |
|---|---|---|---|---|---|
| Structure | Code | Structure | Code | Structure | Code |
| 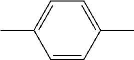 | A | —CF₂O— | X | —CₙH₂ₙ₊₁ | n |
| 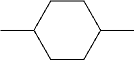 | B | —CH₂CH₂— | N | —OCₙH₂ₙ₊₁ | On |
| 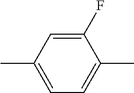 | C | —COO— | L | 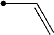 | V |
| 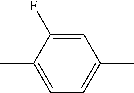 | D | | | 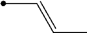 | U1 |
| 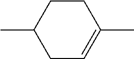 | B′ | | | 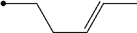 | 3=2 |
| 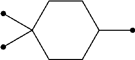 | S | | | 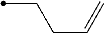 | W |
| 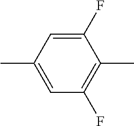 | E | | | —OCF₃ | OCF3 |
| 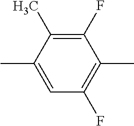 | E1 | | | —F | F |
| 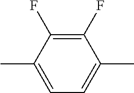 | F | | | —CF₃ | CF3 |
| 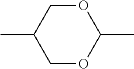 | I | | | —C≡N | CN |
| 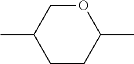 | Ia | | | | |

Referring to Table 1, the following codes denote the liquid crystal compounds of the following structures.

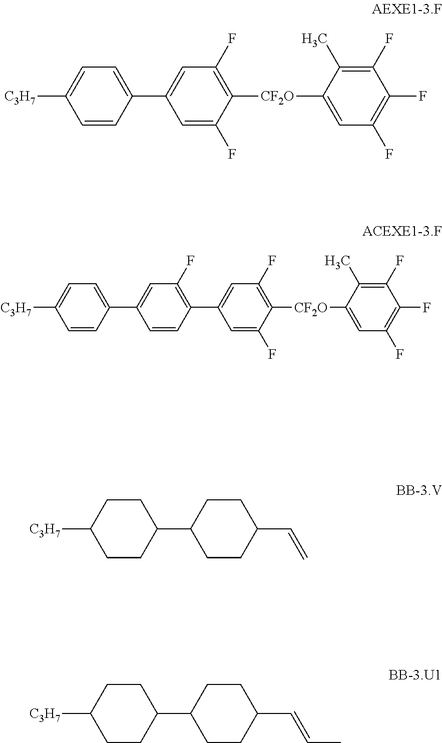

TABLE 2

| | | Comparative | Comparative | Comparative | Comparative | Comparative | Example | Example | Example |
|---|---|---|---|---|---|---|---|---|---|
| | | Example 1 | Example 2 | Example 3 | Example 4 | Example 5 | 1 | 2 | 3 |
| | item | [wt %] | [wt %] | [wt %] | [wt %] | [wt %] | [wt %] | [wt %] | [wt %] |
| Chemical | ACEXE1-2.F | 21.0 | 18.0 | 7.0 | 3.0 | | 14.0 | 11.0 | 8.5 |
| Formula 1 | | | | | | | | | |
| Chemical | ACEXE1-3.F | | 3.0 | 14.0 | 18.0 | 21.0 | 7.0 | 11.0 | 12.5 |
| Formula 2 | | | | | | | | | |
| Chemical | BBE-3.F | 8.0 | 8.0 | 8.0 | 8.0 | 8.0 | 8.0 | 8.0 | 8.0 |
| Formula 3 | | | | | | | | | |
| others | BB-3.V | 35.0 | 35.0 | 35.0 | 35.0 | 35.0 | 35.0 | 35.0 | 35.0 |
| | BAA-3.2 | 3.0 | 3.0 | 3.0 | 3.0 | 3.0 | 3.0 | 3.0 | 3.0 |
| | BBA-V.1 | 7.0 | 7.0 | 7.0 | 7.0 | 7.0 | 7.0 | 7.0 | 7.0 |
| | ACA-3.F | 3.0 | 3.0 | 3.0 | 3.0 | 3.0 | 3.0 | 3.0 | 3.0 |
| | BBA-3.OCF3 | 9.0 | 9.0 | 9.0 | 9.0 | 9.0 | 9.0 | 9.0 | 9.0 |
| | BBE-2.F | 3.0 | 3.0 | 3.0 | 3.0 | 3.0 | 3.0 | 3.0 | 3.0 |
| | BAE-3.F | 5.0 | 5.0 | 5.0 | 5.0 | 5.0 | 5.0 | 5.0 | 5.0 |
| | AEXE1-3.F | 6.0 | 6.0 | 6.0 | 6.0 | 6.0 | 6.0 | 6.0 | 6.0 |
| properties | Low | NG at the | NG at the | NG at the | NG at the | NG at the | 5 days | 5 days | 5 days |
| | temperature | first day | first day | second | second | second | OK | OK | OK |
| | stability | | | day | day | day | | | |
| | Clearing | 79.6 | 79.6 | 80.1 | 80.0 | 80.3 | 79.6 | 80.0 | 80.0 |
| | point [° C.] | | | | | | | | |
| | Refractive | 0.110 | 0.110 | 0.110 | 0.111 | 0.111 | 0.110 | 0.110 | 0.110 |
| | index | | | | | | | | |
| | anisotropy | | | | | | | | |
| | Dielectric | 9.8 | 9.8 | 10.6 | 9.9 | 9.7 | 10.1 | 10.0 | 10.0 |
| | anisotropy | | | | | | | | |
| | Rotational | 48 | 49 | 55 | 74 | 74 | 55 | 56 | 56 |
| | viscosity | | | | | | | | |
| | [mPa · s] | | | | | | | | |

Referring to Table 2, it is confirmed that by using the first liquid crystal compound represented by the Chemical Formula 1 and the second liquid crystal compound represented by the Chemical Formula 2 at a weight ratio of 1:0.5 to 1:1.5, excellent low temperature stability may be secured.

To the contrary, as in Comparative Examples 1 and 2, if the weight ratio of the second liquid crystal compound of the Chemical Formula 2 to the first liquid crystal compound of the Chemical Formula 1 (weight of the second liquid crystal compound/weight of the first liquid crystal compound) is less than 0.5, although rotational viscosity was excellent, a crystal or smetic phase was precipitated at the first day at low temperature.

And, as in Comparative Examples 3 to 5, also in case the weight ratio of the second liquid crystal compound of the Chemical Formula 2 to the first liquid crystal compound of the Chemical Formula 1 (weight of the second liquid crystal compound/weight of the first liquid crystal compound) is greater than 1.5, a crystal or smetic phase was precipitated at the second day at low temperature. And, Comparative Examples 4 and 5 with higher content of the second liquid crystal exhibited very high rotational viscosities.

TABLE 3

| | | Comparative | Comparative | Comparative | Comparative | Comparative | Example | Example | Example |
|---|---|---|---|---|---|---|---|---|---|
| | | Example 6 | Example 7 | Example 8 | Example 9 | Example 10 | 4 | 5 | 6 |
| | item | [wt %] | [wt %] | [wt %] | [wt %] | [wt %] | [wt %] | [wt %] | [wt %] |
| Chemical | ACEXE1-2.F | 15.0 | 12.0 | 5.0 | 3.0 | | 10.0 | 7.5 | 6.3 |
| Formula 1 | | | | | | | | | |
| Chemical | ACEXE1-3.F | | 3.0 | 10.0 | 12.0 | 15.0 | 5.0 | 7.5 | 8.8 |
| Formula 2 | | | | | | | | | |
| Chemical | BBE-3.F | 5.0 | 5.0 | 5.0 | 5.0 | 5.0 | 5.0 | 5.0 | 5.0 |
| Formula 3 | | | | | | | | | |
| Others | BB-3.V | 39.0 | 39.0 | 39.0 | 39.0 | 39.0 | 39.0 | 39.0 | 39.0 |
| | BB-3.U1 | 8.0 | 8.0 | 8.0 | 8.0 | 8.0 | 8.0 | 8.0 | 8.0 |
| | BAA-3.2 | 4.0 | 4.0 | 4.0 | 4.0 | 4.0 | 4.0 | 4.0 | 4.0 |
| | BAA-5.2 | 2.0 | 2.0 | 2.0 | 2.0 | 2.0 | 2.0 | 2.0 | 2.0 |
| | BBA-3.1 | 2.0 | 2.0 | 2.0 | 2.0 | 2.0 | 2.0 | 2.0 | 2.0 |
| | ACA-2.3 | 3.0 | 3.0 | 3.0 | 3.0 | 3.0 | 3.0 | 3.0 | 3.0 |
| | ACA-2.F | 2.0 | 2.0 | 2.0 | 2.0 | 2.0 | 2.0 | 2.0 | 2.0 |
| | ACA-3.F | 3.0 | 3.0 | 3.0 | 3.0 | 3.0 | 3.0 | 3.0 | 3.0 |
| | BBA-3.OCF3 | 8.0 | 8.0 | 8.0 | 8.0 | 8.0 | 8.0 | 8.0 | 8.0 |
| | BAE-3.F | 4.0 | 4.0 | 4.0 | 4.0 | 4.0 | 4.0 | 4.0 | 4.0 |
| | BAC-3.F | 3.0 | 3.0 | 3.0 | 3.0 | 3.0 | 3.0 | 3.0 | 3.0 |
| | BBCE-3.F | 2.0 | 2.0 | 2.0 | 2.0 | 2.0 | 2.0 | 2.0 | 2.0 |
| properties | Low | NG at the | NG at the | 5 days | 5 days | 5 days | 5 days | 5 days | 5 days |
| | temperature | first day | second | OK | OK | OK | OK | OK | OK |
| | stability | | day | | | | | | |
| | Clearing | 84.8 | 83.4 | 85.8 | 85.8 | 86.0 | 83.8 | 85.6 | 86.1 |
| | point [° C.] | | | | | | | | |
| | Refractive | 0.112 | 0.112 | 0.113 | 0.111 | 0.112 | 0.112 | 0.112 | 0.112 |
| | index | | | | | | | | |
| | anisotropy | | | | | | | | |
| | Dielectric | 7.0 | 6.5 | 6.9 | 6.8 | 6.6 | 6.8 | 6.9 | 6.8 |
| | anisotropy | | | | | | | | |
| | Rotational | 70 | 73 | 81 | 81 | 84 | 70 | 70 | 71 |
| | viscosity | | | | | | | | |
| | [mPa · s] | | | | | | | | |

As liquid crystal compositions having dielectric anisotropy of about 6 to 7, liquid crystal compositions of Examples 4 to 6 and Comparative Examples 6 to 10 were prepared. Referring to Table 3, it is confirmed that liquid crystal compositions having dielectric anisotropy of about 6 to 7 may also exhibit excellent low temperature stability together with good properties, by controlling the weight ratio of the first liquid crystal compound and the second liquid crystal compound to 1:0.5 to 1:1.5.

TABLE 4

| | | Example | Example | Example | Example | Example | Example | Example | Example |
|---|---|---|---|---|---|---|---|---|---|
| | | 7 | 8 | 9 | 10 | 11 | 12 | 13 | 14 |
| | item | [wt %] | [wt %] | [wt %] | [wt %] | [wt %] | [wt %] | [wt %] | [wt %] |
| Chemical | ACEXE1-2.F | 10.0 | 7.0 | 8.8 | 8.2 | 12.0 | 12.0 | 12.0 | 13.0 |
| Formula 1 | | | | | | | | | |
| Chemical | ACEXE1-3.F | 13.0 | 7.0 | 13.1 | 12.3 | 6.0 | 7.0 | 10.0 | 10.0 |
| Formula 2 | | | | | | | | | |
| Chemical | BBE-3.F | 6.6 | 7.2 | 5.2 | 10.3 | 12.0 | 12.0 | 12.0 | 13.0 |
| Formula 3 | | | | | | | | | |
| Others | BB-3.V | 37.4 | 34.0 | 37.0 | 35.5 | 28.0 | 30.0 | 30.0 | 33.0 |
| | BB-3.U1 | | | | | | | 2.0 | |
| | BAA-3.2 | 1.0 | 1.6 | 2.6 | 1.4 | 3.0 | | 6.0 | 3.0 |
| | BBA-3.1 | | 8.2 | | 7.1 | 3.0 | 5.0 | | |
| | BBA-V.1 | 8.0 | 9.8 | 8.2 | 7.9 | 3.0 | 5.0 | | |
| | ACA-3.F | | | | | 5.0 | 8.0 | 2.0 | 3.0 |
| | BBA-3.OCF3 | 6.2 | 8.2 | 6.2 | | | | | |
| | BAE-3.F | 7.6 | | 8.2 | 7.9 | 10.0 | 13.0 | 11.0 | 12.0 |
| | BAC-3.F | | | | | 10.0 | | 11.0 | 13.0 |
| | BBE-2.F | 10.2 | | 10.7 | 3.9 | | | | |
| | AEXE1-3.F | | 17.0 | | 5.5 | 8.0 | 8.0 | 4.0 | |
| properties | Low | 5 days | 5 days | 5 days | 5 days | 5 days | 5 days | 5 days | 5 days |
| | temperature | OK | OK | OK | OK | OK | OK | OK | OK |
| | stability | | | | | | | | |
| | Clearing | 79.5 | 80.4 | 80.7 | 81.5 | 75.6 | 75.6 | 75.7 | 75.5 |
| | point [° C.] | | | | | | | | |
| | Refractive | 0.103 | 0.102 | 0.103 | 0.105 | 0.121 | 0.119 | 0.121 | 0.119 |
| | index | | | | | | | | |
| | anisotropy | | | | | | | | |
| | Dielectric | 10.4 | 10.3 | 10.1 | 10.6 | 12.2 | 12.5 | 11.9 | 12.0 |
| | anisotropy | | | | | | | | |
| | Rotational | 72 | 71 | 73 | 70 | 81 | 84 | 85 | 82 |
| | viscosity | | | | | | | | |
| | [mPa · s] | | | | | | | | |

As liquid crystal compositions having dielectric anisotropy of 10 or more, liquid crystal compositions of Examples 7 to 14 were prepared. Referring to Table 4, it is confirmed that by controlling the weight ratio of the first liquid crystal compound the second liquid crystal compound to 1:0.5 to 1:1.5, and controlling the content of the third liquid crystal compound to 2 to 20 wt % base on the total weight of the liquid crystal compounds included in the liquid crystal composition, liquid crystal compositions exhibiting excellent low temperature stability and various properties may be provided.

What is claimed is:

1. A liquid crystal composition comprising
a first liquid crystal compound represented by the following Chemical Formula 1, a second liquid crystal compound represented by the following Chemical Formula 2, and a third liquid crystal compound represented by the following Chemical Formula 3,
wherein the first liquid crystal compound and the second liquid crystal compound are included in the content of 10 to 40 wt %, based on the total weight of the total liquid crystal compounds, and
the first liquid crystal compound and the second liquid crystal compound are included at a weight ratio of 1:0.5 to 1:1.5.

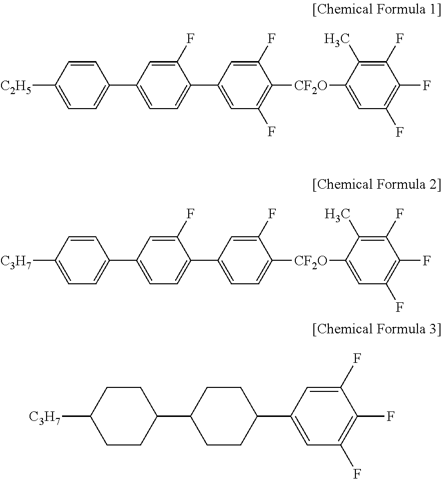

2. The liquid crystal composition according to claim 1, wherein the third liquid crystal compound represented by the Chemical Formula 3 is included in the content of 2 to 20 wt %, based on the total weight of the total liquid crystal compounds.

3. The liquid crystal composition according to claim 1, further comprising a fourth liquid crystal compound represented by the following Chemical Formula 4: 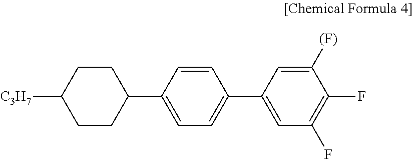
in the Chemical Formula 4, (F) denotes being unsubstituted or substituted with F.

4. The liquid crystal composition according to claim 3, wherein the fourth liquid crystal compound represented by the Chemical Formula 4 is included in the content of 2 to 30 wt %, based on the total weight of the total liquid crystal compounds.

5. The liquid crystal composition according to claim 1, further comprising one or more liquid crystal compounds selected from the group consisting of liquid crystal compounds represented by the following Chemical Formula 5 to Chemical Formula 8: 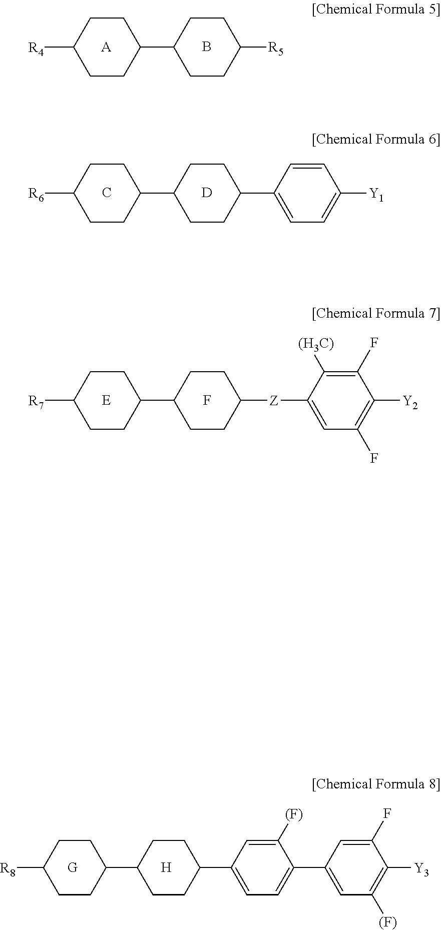
in the Chemical Formulae 5 to 8, each of R₄, R₅, R₆, R₇ and R₈ are independently a C1-7 alkyl radical, or a C1-7 alkyl radical of which at least one H is substituted with halogen, or at least one —CH₂— is replaced with —C≡C—, —CF₂O—, —CH═CH—, —O—, —CO—O—, —O—CO— or —O—CO—O— so that oxygen atoms are not directly connected,
Y₁ is a C1-7 alkyl radical, F or OCF₃,
each of Y₂ and Y₃ are independently F, OCF₃ or CF₃,
each of the ring A, ring B, ring C, ring E and ring G are independently cyclohexylene or phenylene,
each of the ring D, ring F and ring H are independently cyclohexylene, phenylene, fluorophenylene or difluorophenylene,
Z is a single bond, —CF₂O—, or —CH₂CH₂—,
(CH₃) denotes being unsubstituted or substituted with a methyl radical, and
(F) denotes being unsubstituted or substituted with F,
provided that among the structures derived from the Chemical Formula 7, the structures of the Chemical Formula 3 and Chemical Formula 4 are excluded.
